(19) United States
(12) Patent Application Publication
(10) Pub. No.: US 2017/0263047 A1
(43) Pub. Date: Sep. 14, 2017

(54) DISPLAY APPARATUS

(71) Applicant: Panasonic Intellectual Property Management Co., Ltd., Osaka (JP)

(72) Inventor: Kunihiro MIMA, Kyoto (JP)

(21) Appl. No.: 15/428,591

(22) Filed: Feb. 9, 2017

Related U.S. Application Data
(63) Continuation of application No. PCT/JP2016/003665, filed on Aug. 9, 2016.

(30) Foreign Application Priority Data
Mar. 10, 2016 (JP) 2016-046737

(51) Int. Cl. G06T 15/50; G06F 3/00; G06T 15/20

(52) U.S. Cl. CPC G06T 15/506; G06T 15/205; G06F 3/002; G06T 2215/16

(57) ABSTRACT

Included are display unit (2) configured to display an image, recording unit (3) configured to record three-dimensional data of an object to be displayed on display unit (2), and arithmetic unit (4) configured to, based on a first irradiation direction in which luminance of light irradiated on display unit (2) is highest, a first luminance of light from the first irradiation direction, and a second luminance of light from a direction other than the first irradiation direction, the second luminance being lower than the first luminance, calculate a shape of a shade of the object using the three-dimensional data and the first irradiation direction, calculate a density of the shade using the first luminance, and calculate a correction coefficient of the density of the shade using the second luminance. Display unit (2) displays an image of the object being shaded based on a result calculated by arithmetic unit (4).

### BACKGROUND

1. Technical Field

The present disclosure relates to a display apparatus capable of displaying a shaded image of an object.

2. Description of the Related Art

PTL 1 discloses a shade setting device for shading various objects having a specified shape using computer graphics. The apparatus preliminarily sets the position of a virtual light source in an image and shades an object in an image.

### CITATION LIST

### Patent Literature

PTL 1: Unexamined Japanese Patent Publication No. 2000-285254

### SUMMARY

The present disclosure provides a display apparatus capable of shading an object in tune with environment light and without giving any uncomfortable feeling.

A display apparatus according to the present disclosure includes a display unit configured to display an image, a recording unit configured to record three-dimensional data of an object to be displayed on the display unit, and an arithmetic unit configured to, on the basis of a first irradiation direction in which luminance of light irradiated on the display unit is highest, a first luminance of light from the first irradiation direction, and a second luminance of light from a direction other than the first irradiation direction, the second luminance being lower than the first luminance, calculate a shape of a shade of the object using the three-dimensional data and the first irradiation direction, calculate a density of the shade using the first luminance, and calculate a correction coefficient of the density of the shade using the second luminance. The display unit displays an image of the object being shaded on the basis of a result calculated by the arithmetic unit.

The display apparatus according to the present disclosure makes it possible to shade an object in tune with environment light and without giving any uncomfortable feeling.

### BRIEF DESCRIPTION OF THE DRAWINGS

FIG. 1 is a block diagram illustrating a configuration of a display apparatus according to a first exemplary embodiment;

FIG. 2 is a diagram illustrating a problem of a display apparatus in a conventional technique;

FIG. 3 is a diagram illustrating the display apparatus according to the first exemplary embodiment;

FIG. 4A is a diagram illustrating an original image;

FIG. 4B is a diagram illustrating the shape of a shade to the original image;

FIG. 4C is a diagram illustrating a case where shading is performed without correcting its density;

FIG. 4D is a diagram illustrating a case where shading is performed with a corrected density;

FIG. 5 is a block diagram illustrating a configuration of a display apparatus in a modification of the first exemplary example;

FIG. 6A is a diagram illustrating a density difference correction in the modification of the first exemplary embodiment;

FIG. 6B is a diagram illustrating a density difference correction in the modification of the first exemplary embodiment;

FIG. 6C is a diagram illustrating a density difference correction in the modification of the first exemplary embodiment;

FIG. 7 is a diagram illustrating a display apparatus according to a second exemplary embodiment;

FIG. 8 is a block diagram illustrating a configuration of a detector of the display apparatus according to the second exemplary embodiment;

FIG. 9A is a diagram illustrating a luminance distribution around a light axis of a camera;

FIG. 9B is a diagram illustrating a luminance distribution on dotted line L1 of FIG. 9A; and

FIG. 10 is a block diagram of the display apparatus in which an arithmetic unit in FIG. 1 is connected to the detector in FIG. 8.

### DETAILED DESCRIPTION

Referring to the drawings appropriately, exemplary embodiments will be described in detail below. Some detailed description will be omitted more than necessary. For example, a detailed description of well-known matters and a duplicate description for the configuration of substantially the same matter may be omitted. This is to avoid causing description to be unnecessarily verbose, and to facilitate the understanding of those skilled in the art.

It should be noted that the inventor(s) provides (provide) accompanying drawings and the following description for those skilled in the art in order to fully understand the present disclosure. It is not intended to limit the subject matter of the claims by those.

Problem with Conventional Art

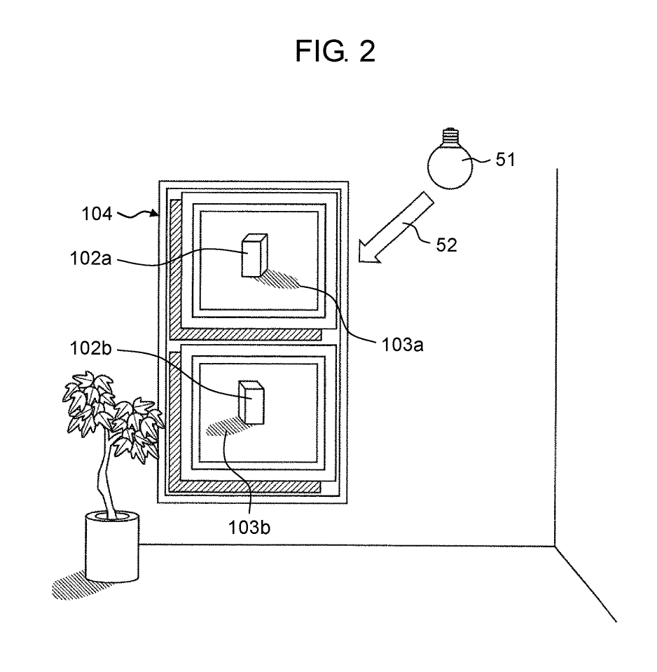

In PTL 1, as illustrated in FIG. 2, the position of a virtual light source in an image is set regardless of the irradiation direction of direct light 52 from light source 51 with respect to display 104, shades 103a, 103b are applied to objects 102a, 102b in the image, respectively, to display the image on display 104. For example, in FIG. 2, light source 51 is disposed at an upper right of display 104, and the irradiation direction of direct light 52 from light source 51 is from an upper right to a lower left of display 104. At this time, shade 103b of object 102b on the lower side of display 104 is displayed from an upper right to a lower left, which is natural. However, shade 103a of object 102a on the upper side of display 104 is displayed from an upper left to a lower right, which is unnatural. In this manner, when an image on which shading is performed at a position where no shading should be performed normally is displayed on display 104, an observer feels uncomfortable, resulting in deterioration of reality.

Therefore, the present disclosure provides a display apparatus that prevents an observer from felling uncomfortable to deteriorate reality by displaying a shade in tune with the irradiation direction of a light source.

### First Exemplary Embodiment

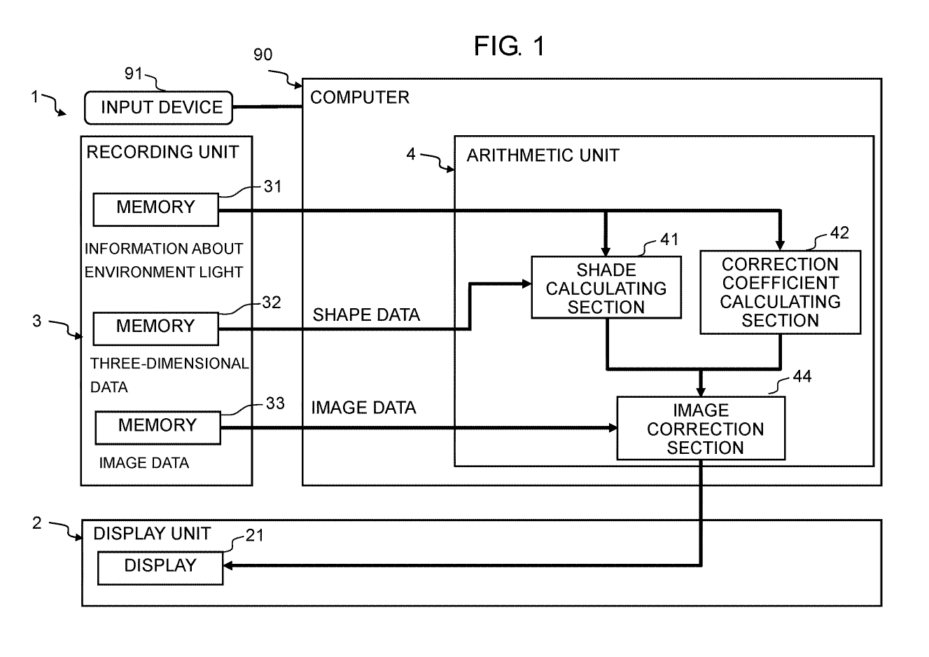

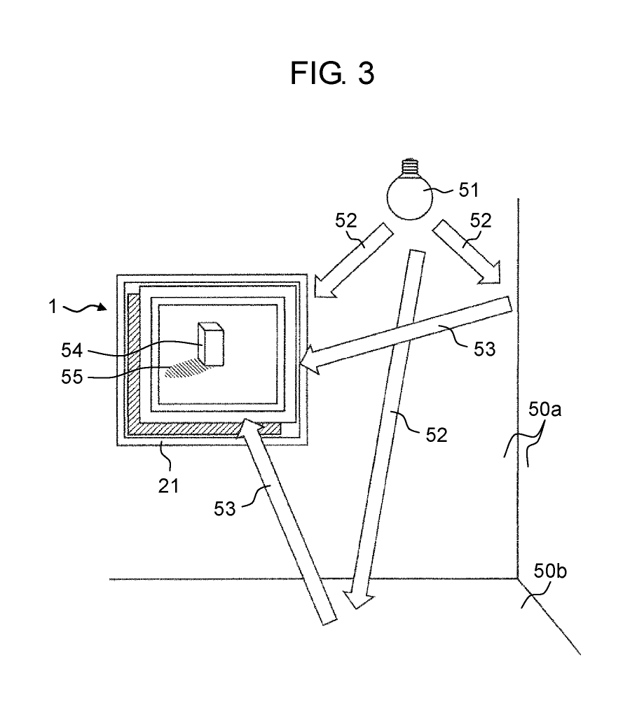

Hereinafter, a first exemplary embodiment will be described with reference to FIG. 1, and FIG. 3 to FIG. 6C.

### [1-1. Configuration]

FIG. 3 is a diagram illustrating display apparatus 1 according to the first exemplary embodiment. As illustrated in FIG. 3, when light from light source 51 is irradiated on display apparatus 1, two types of light are irradiated on display apparatus 1. One is direct light 52 directly irradiated on display apparatus 1 from light source 51, and the other is ambient light 53 indirectly irradiated on display apparatus 1 after direct light 52 is reflected by wall 50a, floor 50b, etc.

FIG. 1 is a block diagram illustrating a configuration of display apparatus 1 according to the first exemplary embodiment.

As illustrated in FIG. 1, display apparatus 1 in the first exemplary embodiment includes at least display unit 2, recording unit 3, and arithmetic unit 4.

Display unit 2 includes at least display 21, and makes an image formed by arithmetic unit 4 be displayed on display 21.

Recording unit 3 records at least data (three-dimensional data and image data) of object 54 (see FIG. 3) to be displayed on display 21, and information about light (environment light) to be irradiated on display 21 from light source 51. The above data is generated by preliminarily imaging object 54 that is a subject. The above data and information may be directly recorded in recording unit 3, or the recording unit 3 may obtain record information recorded in a data base not shown via a storage medium or using communication means or the like.

The recording unit 3 includes, for example, memory 31, memory 32, and memory 33.

In memory 32, three-dimensional data of object 54 is recorded, and the recorded three-dimensional data is used in shade calculating section 41 of arithmetic unit 4.

In memory 33, image data of object 54 is recorded, and the recorded image data is used in image correction section 44 of arithmetic unit 4.

In memory 31, information about environment light irradiated on display 21 from light source 51 is stored. The information about environment light includes information about direct light 52 directly irradiated on display 21 from light source 51, and information about ambient light (indirect light) 53 irradiated on display 21 after reflected by wall 50a, floor 50b etc. Furthermore, the information about direct light 52 includes two items of information. One is information about irradiation direction of direct light 52 having the maximum luminance among the light directly irradiated on display 21, and the irradiation direction is defined as a first irradiation direction. The other is information about the luminance of direct light 52 from the first irradiation direction, and the luminance is defined as a first luminance. The information about ambient light 53 is information of the luminance of ambient light 53 lower than the first luminance and irradiated on display 21 from a direction other than the first irradiation direction, and the luminance is defined as a second luminance. Memory 31 records information about environment light irradiated on display 21 from light source 51. More specifically, memory 31 records the first irradiation direction, the first luminance, and the second luminance of light source 51. The information about environment light is used in shade calculating section 41 and correction coefficient calculating section 42 of arithmetic unit 4.

On the basis of the three-dimensional data, the first irradiation direction, the first luminance, and the second luminance recorded in recording unit 3, arithmetic unit 4 calculates the shape of the shade of object 54 using the three-dimensional data and the first irradiation direction, and calculates the density of the shade using the first luminance, and calculates a correction coefficient of the density of the shade using the second luminance.

As an example, arithmetic unit 4 can be provided by computer 90 capable of executing a computer program written by software or firmware for calculation processing. To computer 90, display unit 2, recording unit 3, and input device 91 capable of inputting various input information are connected.

Specifically, arithmetic unit 4 includes shade calculating section 41, correction coefficient calculating section 42, and image correction section 44.

Shade calculating section 41 calculates the shape of the shade of object 54 using the three-dimensional data and the first irradiation direction recorded in recording unit 3, and calculates the density of the shade using the first luminance.

Correction coefficient calculating section 42 calculates the correction coefficient of the density of the shade using the second luminance recorded in recording unit 3.

Image correction section 44 calculates the density of shade 55 (see FIG. 3) that should be displayed by multiplying the density of the shade calculated by the shade calculating section 41 by the correction coefficient of the density of the shade calculated by correction coefficient calculating section 42. Image correction section 44 corrects/forms an image on the basis of the image data of object 54 recorded in memory 33, the shape of shade 55 calculated by shade calculating section 41, and the calculated density of shade 55.

Display unit 2 is configured by, for example, display 21, and display 21 displays an image formed by image correction section 44 of arithmetic unit 4.

Herein, the reason of using the correction coefficient of the density of the shade calculated by using the second luminance instead of using the density of the shade calculated by using the first luminance without change.

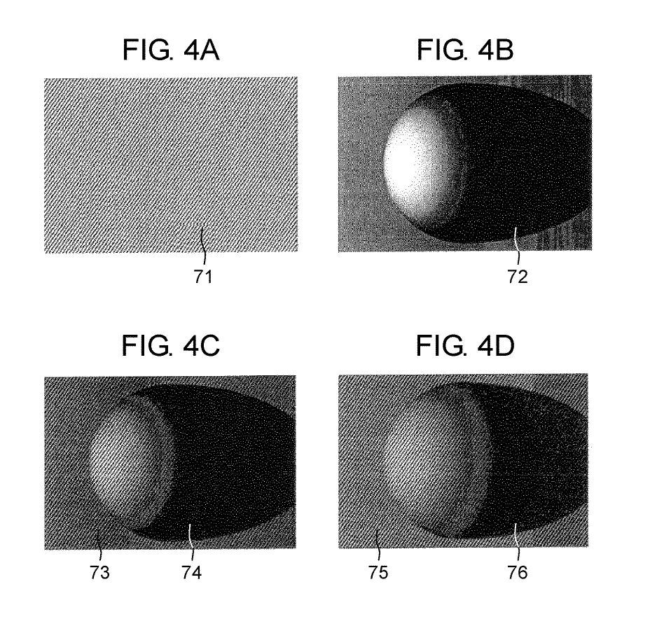

Consider a case where shade 72 (e.g., shade based on asperities of brushing touch) generated to an object having a hemispherical shape as illustrated in FIG. 4B due to the light from the first irradiation direction of direct light 52 is overlapped with original image 71 (e.g., image of picture imaged such that shading is not performed) that is to be shaded as illustrated in FIG. 4A. In this context, shade calculating section 41 calculates the shade using three-dimensional data and the first luminance of direct light 52.

Herein, when original image 71 is shaded with only direct light 52, shade 74 in processed image 73 becomes too dense, resulting in an image different from the actual appearance as illustrated in FIG. 4C.

Display apparatus 1 calculates a correction coefficient corresponding to ambient light 53, multiplies the density of the shade calculated by shade calculating section 41 by the correction coefficient, and processes original image 71. As illustrated in FIG. 4D, this yields processed image 75 formed by processing original image 71 by multiplying the density of the shade by the correction coefficient corresponding to ambient light 53. Shade 76 of processed image 75 illustrated in FIG. 4D becomes light as compared with shade 74 of processed image 73 illustrated in FIG. 4C, coming close to actual appearance.

As the correction coefficient, for example, the density of the shade is set such that the variation of gradation from 0 (dark) to 255 (bright) is suppressed to the variation of gradation from 165 (middle) to 255 (bright). That is, the density of shade is adjusted by the correction coefficient.

Next, an example of a specific method of obtaining the density of the shade using the correction coefficient will be described.

The density of the shade is a relative angle relationship between light source 51 and each surface constituting object 54, and is determined by shade calculating section 41. For example, in shade calculating section 41, the inner product of normal vector N of each surface of object 54 and light source vector d is calculated to thereby calculate the angel θ between both the vectors, and the density of the shade (e.g., 1−cos θ) is calculated.

Specifically, when θ=0°, light from light source 51 is incident on the surface that should determine the shade of object 54 at right angle, so that the density of the shade becomes 0 (bright portion).

When θ=90°, light of light source 51 is incident on the surface that should determine the shade of object 54 along its surface, so that the density of the shade becomes 1 (dark portion).

A shade can be displayed by multiplying each of levels of RGB (red-green-blue) of image data by, for example, (1−cos θ) by shade calculating section 41.

Herein, given that the total sum of luminance in a high luminance area where luminance is higher than a preliminarily determined luminance threshold value is S1, and the total sum of luminance in a low luminance area where luminance is lower than the luminance threshold value is S2, it is necessary to reduce the shade by the light source by the luminance in the low luminance area. This is because when the shade by the light source is not reduced, that is, when the calculated density of the shade is used without change, the shade becomes too dense, which may result in an appearance different from the actual appearance. Accordingly, correction coefficient calculating section 42 calculates correction coefficient=S1/(S1+S2) of the density of the shade. Then, image correction section 44 multiplies the density of the shade calculated by shade calculating section 41 by the correction coefficient of the density of the shade calculated by correction coefficient calculating section 42. Forming an image on the basis of the density of the shade, for example, the density of the shade obtained by using the correction coefficient×(1−cos θ) makes it possible to display a naturally shaded image).

Herein, as the way of setting the luminance threshold value, the following methods can be exemplified. A first method employs an intermediate value between the maximum value of the luminance of the environment light and the average value of the luminance of the environment light. However, there is no need to employ the intermediate value, and the luminance threshold value may be set to be a rather high value depending on dispersion of the luminance of ambient light 53. A second method employs the intermediate value of the maximum value of the luminance of environment light. However, there is no need to employ the intermediate value, and the luminance threshold value may be set to be a rather high value depending on dispersion of the luminance of ambient light 53.

### [1-2. Effects, Etc.]

Such a configuration of the first exemplary embodiment can perform, in consideration of the irradiation direction from the light source 51, shading in tune with the irradiation direction. This makes it possible to display an image that does not make an observer feel uncomfortable and that does not deteriorate reality.

Furthermore, considering also ambient light 53 that is indirect light in addition to direct light 52 makes the shade light, making it possible to display a naturally shaded image. That is, shading is possible in consideration of ambient luminance (luminance of ambient light 53). In contrast, the conventional method considers only direct light 52 from light source (e.g. electric light) 51, so that shade becomes dense, resulting in an appearance different from the actual appearance. Such a problem can be completely solved in display apparatus 1 according to the first exemplary embodiment. In other words, display apparatus 1 makes it possible to display a naturally shaded image in consideration of the position (first irradiation direction) of light source 51, the maximum luminance (first luminance), and ambient luminance such as indirect light (second luminance). This is because the shape of shade 55 of object 54 is calculated using the three-dimensional data of object 54 and the first irradiation direction, the correction coefficient of the density of shade 55 is calculated using the second luminance after the density of shade 55 is calculated using the first luminance, and the density of shade 55 is adjusted in consideration of ambient luminance. This makes it possible to vary the density of the shade in consideration of ambient luminance, making it possible to display a naturally shaded image. This makes it possible to appreciate arts with reality when a work of art is displayed on display 21 at, for example, a remote position.

### [1-3. Modification]

Herein, when, for example, a work of art is displayed on display 21, there occurs no problem in a display having a high resolution, but there is a risk in that a dark shade portion is emphasized too much to deteriorate image quality in a display having a low resolution.

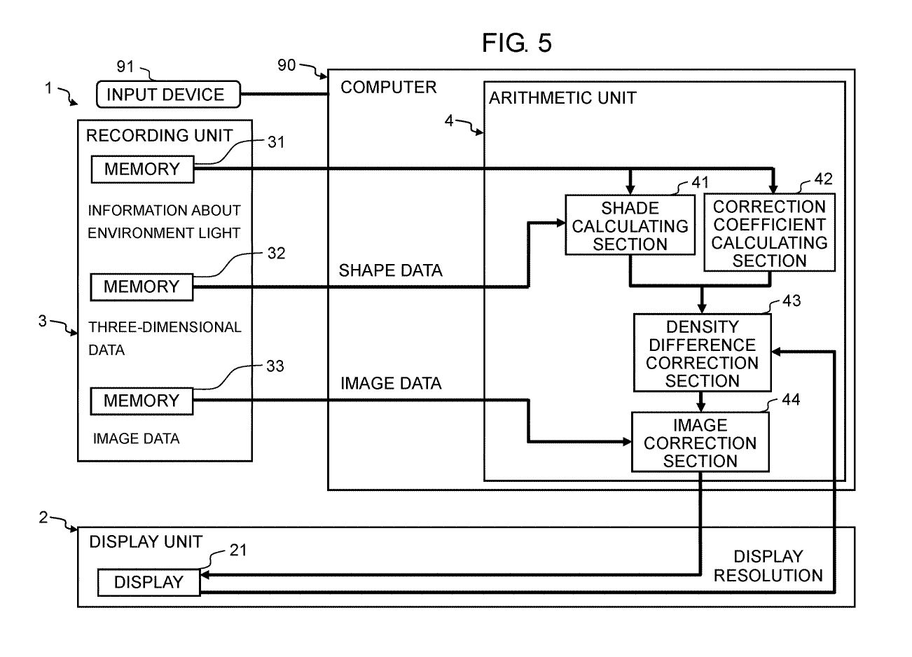

Thus, on the basis of resolution information of the display, no correction is performed in the case of a display having a high resolution, but correction is performed in the case of a display having a low resolution, that is, gradation change is suppressed so as not to emphasize a dark shade portion too much. To this end, arithmetic unit 4 further includes density difference correction section 43 to perform a density difference correction (see FIG. 5).

To density difference correction section 43, information of the resolution of display 21 is input from display 21, and density difference correction section 43 determines whether the resolution of display 21 exceeds a threshold value that is a preliminarily set resolution on the basis of the information. The threshold value of the resolution to determine whether resolution of display is a high resolution or a low resolution may be arbitrarily set in density difference correction section 43 by a user using input device 91 or the like, or may be preliminarily set at a manufacturing stage, depending on the object to be displayed on the display 21.

Hereinafter, density difference correction performed by density difference correction section 43 will be described.

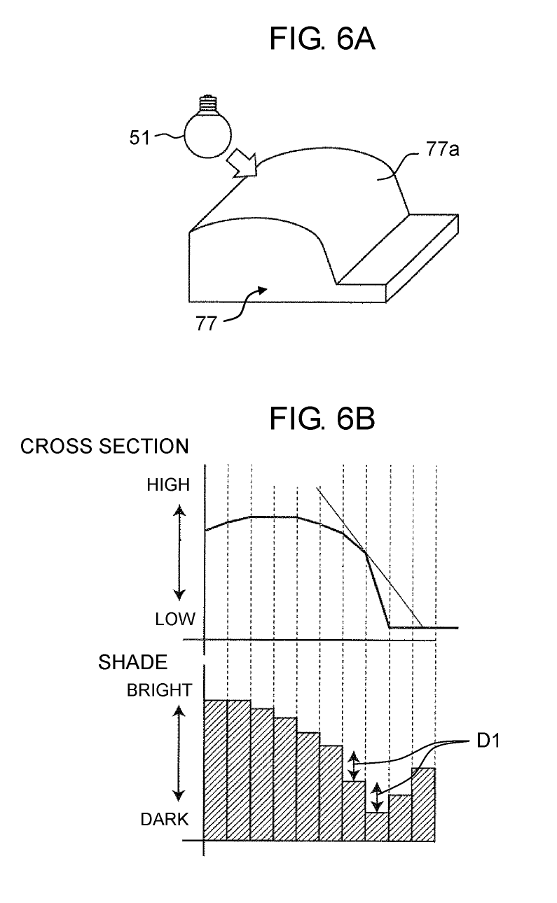

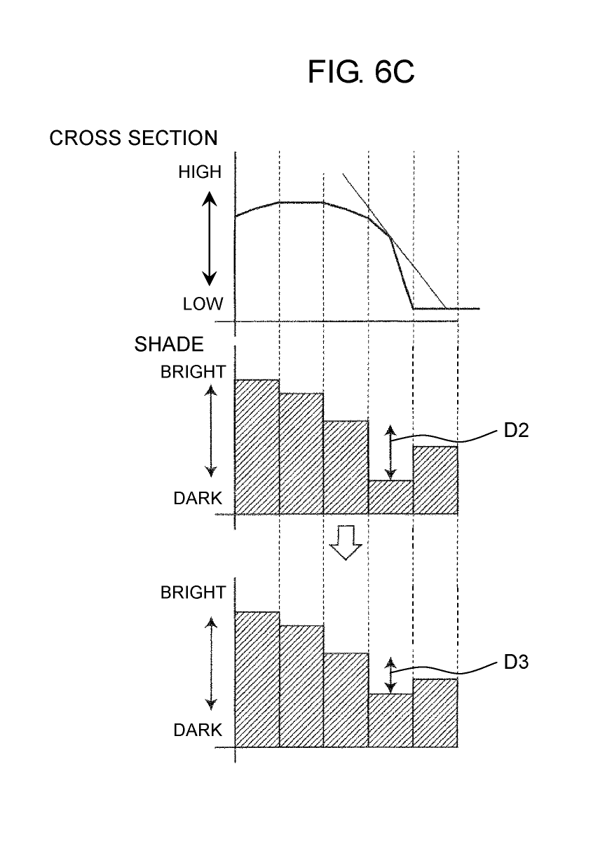

Herein, as one example, an arrangement state to be described below is assumed. To object 77 illustrated in FIG. 6A, light source 51 is disposed at an upper left portion, and light is irradiated to object 77 from light source 51 from upper left to lower right, and a shade formed on the right side of projection 77a of object 77 is considered. The density difference correction herein denotes a density difference correction to be performed when gradations of respective adjacent pixels are largely different depending on the resolution of display 21 at the stage of actual display on display 21 after the shape of shade, the density of shade, and the correction coefficient of the density of shade are calculated.

In the shade at projection 77a, first, when display is performed by display 21 having a high resolution, as illustrated in FIG. 6B, a shaded image in which gradation difference D1 between adjacent pixels is small is displayed (see the lower graph of FIG. 6B) depending on the cross section of object 77 (see the upper graph of FIG. 6B).

In contrast, when display is performed by display 21 having a low resolution, as illustrated in FIG. 6C, a shaded image having large gradation difference D2 between adjacent pixels is displayed (see the middle graph of FIG. 6C) depending on a cross section of object 77 (see the upper graph of FIG. 6C). This means that the shade is emphasized too much to deteriorate image quality, resulting in displaying an unnatural image. In order to address this problem, density difference correction section 43 corrects density difference to reduce the shade of projection 77a that is a low luminance area in which a gradation difference between adjacent pixels is large. This correction reduces gradation difference from gradation difference D2 to gradation difference D3 so that the dark shade portion is prevented from being emphasized too much to suppress a large gradation change, making it possible to prevent deterioration of image quality (see the lower graph of FIG. 6C). For example, supposing that there is a portion where density difference between adjacent cells (adjacent pixels in adjacent pixel area of the shape of the shade in display 21) exceeds a threshold value of density difference correction. In this case, the densities of the respective shades of adjacent cells are adjusted for correction such that the density difference between the adjacent cells at the portion becomes not more than the threshold value of density difference correction.

Herein, an example of the procedure of the density difference correction will be described below.

First, a first step calculates the density difference between attention pixel a and adjacent pixel b adjacent to attention pixel a.

Next, a second step reduces the density of the shade of a darker pixel to become bright when the calculated density difference exceeds a threshold value of density difference correction. When the density of the shade is reduced so as to be bright, the density difference after correction is made to be not more than a threshold value for the density difference correction. Note that when the calculated density difference does not exceed a threshold value of density difference correction, no correction is performed.

Next, a third step considers the case where a darker pixel is adjacent pixel b adjacent to attention pixel a. In this case, correction is performed to reduce the density of the shade in adjacent pixel b so as to be bright such that the density difference becomes not more than a threshold value. In this context, even when the density of the shade of adjacent pixel b becomes light as compared with the density of the shade of a surrounding pixel of adjacent pixel b as a result of calculation by density difference correction section 43, correction is performed such that the density of the shade of adjacent pixel b does not exceed the density of the shade of a surrounding pixel of adjacent pixel b. That is, by the correction processing, adjacent pixel b is suppressed in drastic change of the shade as compared with a surrounding pixel of adjacent pixel b to match the shade of adjacent pixel b with the surrounding shade, thereby suppressing unintended deterioration of image quality due to the correction processing. In the correction procedure, the second step is the order to be processed first, but as a condition, the third step is made to be prioritized. That is, adjacent pixel b is corrected such that the density difference with respect to attention pixel a does not exceed the density of the shade of not more than a threshold value of density difference correction and the density of the shade of a surrounding pixel of adjacent pixel b other than attention pixel a.

Such a configuration makes it possible to perform correction of density difference so as to suppress a large gradation change by density difference correction section 43 even when shade is emphasized too much to deteriorate image quality due to display 21 having a low resolution, making it possible to prevent lowering of image quality.

### Second Exemplary Embodiment

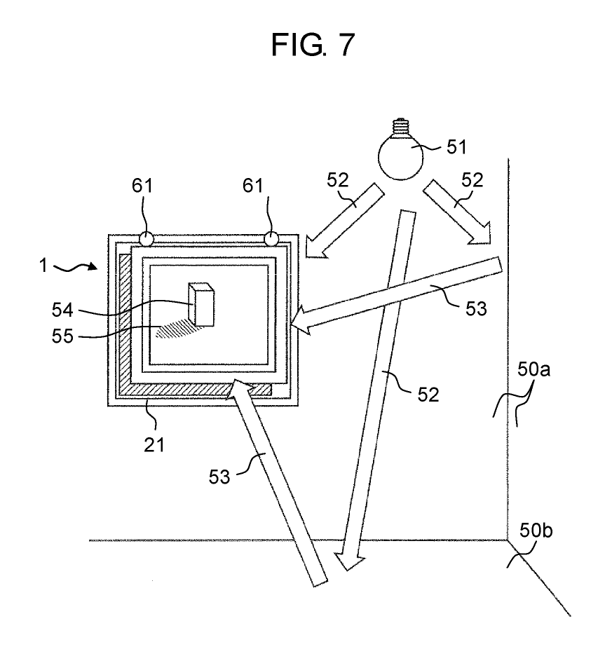

Hereinafter, a second exemplary embodiment will be described with reference to from FIG. 7 to FIG. 10.

### [2-1. Configuration]

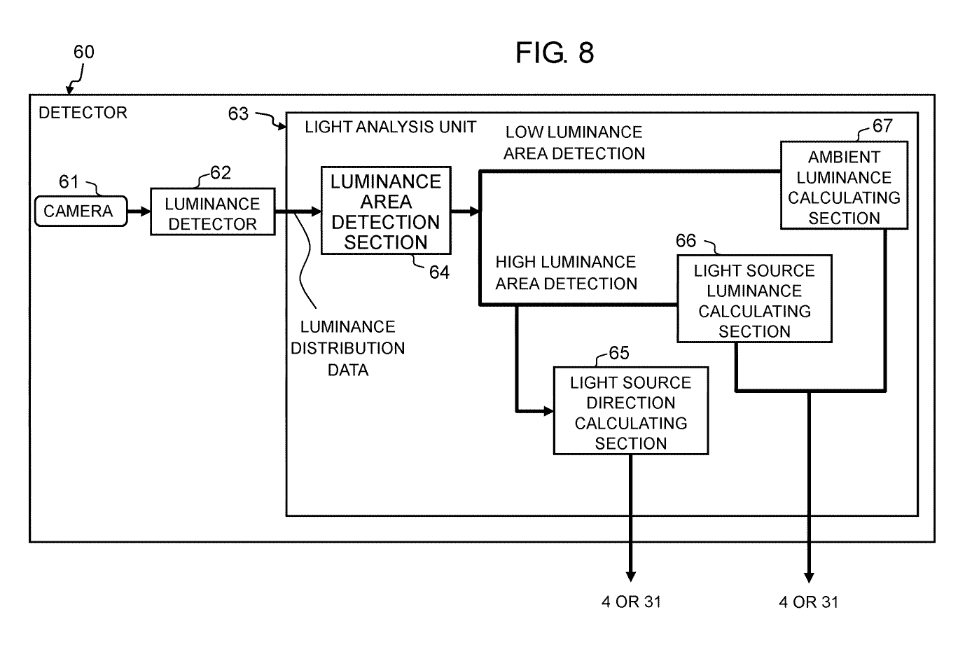

The first exemplary embodiment uses the first irradiation direction, the first luminance, and the second luminance preliminarily stored in recording unit 3. As illustrated in FIG. 7 and FIG. 8, the second exemplary embodiment may detect the positional relationship between the disposed position of display 21 and light source 51 by the detector 60 (see FIG. 8) to acquire the first irradiation direction, the first luminance, and the second luminance using the detection result.

Accordingly, in display apparatus 1 according to the second exemplary embodiment, at least one detector 60 is disposed at a periphery of display 21. Detector 60 includes camera 61, luminance detector (luminance detection unit) 62, and light analysis unit 63. Light analysis unit 63 includes luminance area detection section 64, light source direction calculating section (first irradiation direction calculating section) 65, light source luminance calculating section (first luminance calculating section) 66, and ambient luminance calculating section (second luminance calculating section) 67. Light analysis unit 63 is capable of being provided by computer 90 capable of executing a computer program written by software or firmware for arithmetic processing. Detector 60, display unit 2, input device 91 capable of inputting various input information, and recording unit 3 are connected to computer 90.

In FIG. 7, two cameras 61 are disposed near both ends of the upper rim of display 21. Herein, the emission position of light source 51 is acquired by imaging a periphery of display 21 by two cameras 61 to acquire the first irradiation direction, the first luminance, and the second luminance and record them in recording unit 3. Alternatively, one camera 61 may be made to move at positions near respective ends of the upper rim of display 21 to image peripheries of display 21 at the positions to achieve the operational advantage same as that in the case where two cameras 61 are disposed.

Arrangement of a plurality of cameras 61 makes it possible to acquire information about emission position of light source 51, distance from display 21, and the like more accurately as compared with the case of using one camera 61.

An example of cameras 61 is a digital camera having a charge-coupled device (CCD) image sensor, and each of cameras 61 images an image at a periphery of display 21 at each position.

Luminance detector 62 creates a luminance distribution using the images at respective peripheries of display 21 imaged by two cameras 61.

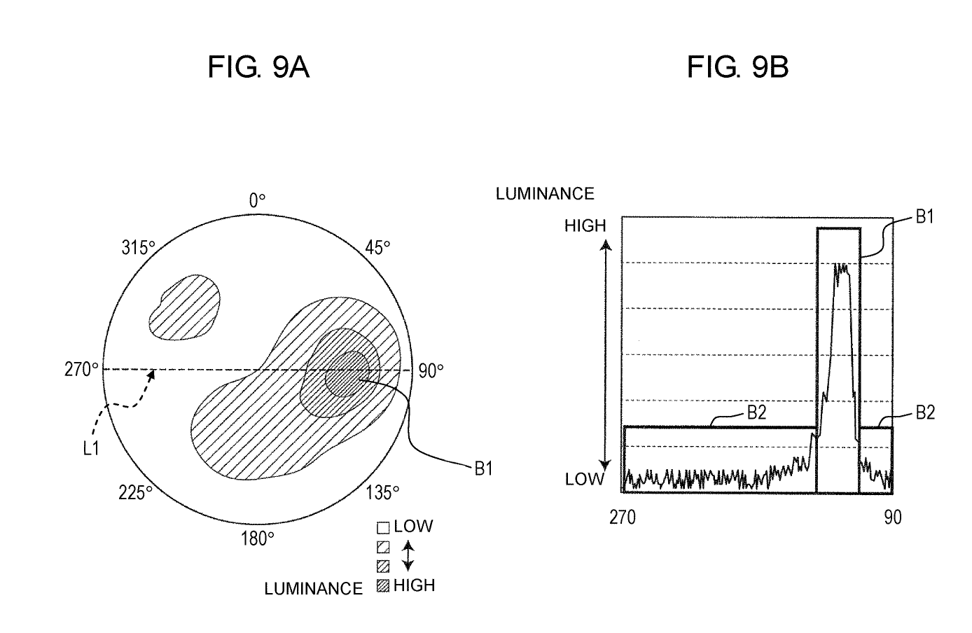

Light analysis unit 63 analysis a luminance distribution created by luminance detector 62, and detects the first irradiation direction, the first luminance, and the second luminance. FIGS. 9A, 9B each illustrate an example of the luminance distribution created by luminance detector 62. FIG. 9A is a diagram illustrating a luminance distribution of 360 degrees around a light axis of one camera 61. FIG. 9B is a diagram illustrating a luminance distribution obtained by camera 61, and the luminance distribution is of a cross section from 90 degrees to 270 degrees illustrated by dotted line L1 of FIG. 9A.

Luminance area detection section 64 of light analysis unit 63 detects the light having the highest luminance (the light having the highest luminance in high luminance area B1 in the luminance distribution of FIG. 9A and in high luminance area B1 in the luminance distribution of FIG. 9B) among the images imaged by cameras 61 to detect high luminance area B1 having luminance of not less than a luminance threshold value, and low luminance area B2 having luminance of less than the luminance threshold value.

Light source direction calculating section (first irradiation direction calculating section) 65 determines that the direction in which the light having the highest luminance among high luminance area B1 is irradiated (e.g., irradiation direction of parallel light) is the first irradiation direction on the basis of the luminance of the high luminance area B1, and sends the information of the first irradiation direction to arithmetic unit 4 or records the information of first irradiation direction in memory 31. As a method of specifically determining the first irradiation direction by light source direction calculating section 65, whether the light of high luminance area B1 is parallel light or radial light is determined. In the case of parallel light, the direction is defined as the first irradiation direction, and in the case of radial light, the position of light source 51 is calculated in consideration of the distance between cameras 61 (or camera detection positions) to determine the first irradiation direction.

Furthermore, light source luminance calculating section (first luminance calculating section) 66 detects the sum of the luminance in high luminance area B1 on the basis of the luminance in high luminance area B1 as a first luminance, and sends the information of the first luminance to arithmetic unit 4 or records the information of the first luminance in memory 31.

Furthermore, ambient luminance calculating section (second luminance calculating section) 67 detects sum of the luminance in low luminance area B2 on the basis of the luminance of low luminance area B2 as a second luminance, and sends the information of the second luminance to arithmetic unit 4 or records the information of the second luminance in memory 31.

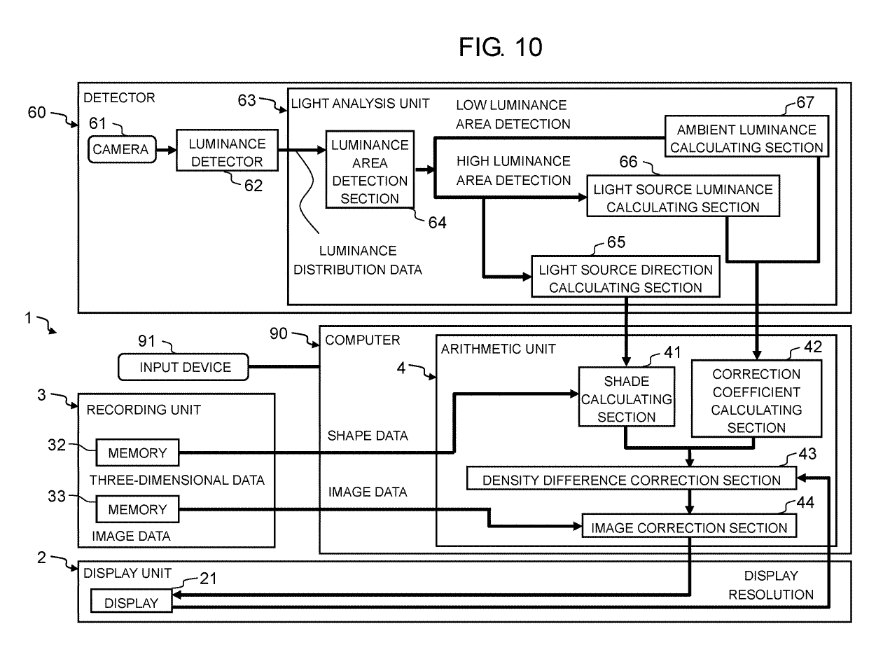

FIG. 10 is a block diagram of the display apparatus in which the detector of FIG. 8 is connected to the arithmetic unit of FIG. 1.

Herein, the light having the first luminance is first light (direct light 52) having a luminance of not less than a luminance threshold value and irradiated from light source 51 along the first irradiation direction. The light having a second luminance has a luminance of less than the luminance threshold value and is light different from the first light irradiated from light source 51 (ambient light 53 or light from a light source different from the light source from which the first light is irradiated). Herein, an example of light source 51 is a single spot light irradiated toward display 21, and an example of a light source different from the light source from which the first light is irradiated is a single light source or a plurality of light sources disposed on the ceiling or the like of the room in which display 21 is disposed. Furthermore, ambient light 53 denotes light irradiated on display 21 after reflected at wall 50a, floor 50b or the like among the light irradiated from light source 51. The light from a light source different from the light source from which the first light is irradiated denotes the light irradiated from a light source different from the light source from which the first light is irradiated on display 21 after reflected by wall 50a, floor 50b, or the like, and the light directly irradiated on display 21 from a light source different from the light source from which the first light is irradiated.

Note that, light source direction calculating section 65 can determine the first irradiation direction at least when detector 60 can detect which direction direct light 52 comes from when viewed from the center of display 21. When the first irradiation direction can be determined, light source luminance calculating section 66 can regard the luminance of the light from the first irradiation direction as the first luminance, and ambient luminance calculating section 67 can regard the luminance of other light as the second luminance.

### [2-2. Effects, etc.]

Since the first irradiation direction, the first luminance, and the second luminance with respect to display 21 are detected by a single camera 61 or a plurality of cameras 61, and luminance detector 62, even when setting conditions are changed, a shade in tune with the irradiation direction of light source 51 can be displayed, so that the observer does not feel uncomfortable and reality is not deteriorated. Herein, change of the setting conditions denotes a case where the position of display 21 is changed or position, intensity (type), or the number of light source 51 is changed to become a state different from the first irradiation direction, the first luminance, and the second luminance recorded in recording unit 3. Accordingly, the configuration of the second exemplary embodiment makes it possible to arbitrarily set the emission position of light source 51 or the setting position of display 21. Furthermore, the configuration of the second exemplary embodiment makes it possible to address parallel light such as sun light or radial light such as light illumination, and to address the case where there exists a plurality of light sources. This allows the shade of a subject to be displayed truly, making it possible to express natural texture. Furthermore, employing a high-resolution display in display 21 makes it possible to truly display the shade of a subject and express natural texture.

### Other Exemplary Embodiments

As described above, as examples of the technique disclosed in the present disclosure, the first to second exemplary embodiments are described. However, the technique in the present disclosure is not limited thereto, and is also applicable to exemplary embodiments in which modification, substitution, addition, omission, or the like is performed as necessary. Furthermore, some constituent elements described in the above first and second exemplary embodiments can be combined to create a new exemplary embodiment.

Hereinafter, other exemplary embodiments will be exemplified.

In the second exemplary embodiment, the configuration is exemplified in which camera 61 as an example the detector is configured by a CCD image sensor. Herein, camera 61 only needs to image a subject to create image data. Accordingly, camera 61 is not limited to a CCD image sensor. However, using a CCD image sensor as camera 61 allows camera 61 to be easily obtained at low cost. Furthermore, a complementary metal oxide semiconductor (CMOS) image sensor may be used as camera 61. Using a CMOS image sensor as camera 61 is valid in suppressing power consumption.

In the first and second exemplary embodiments, computer 90 is described as an example of the arithmetic unit. The arithmetic unit may be physically configured in any manner as long as a predetermined calculation can be executed. Accordingly, the arithmetic unit is not limited to computer 90. However, using computer 90 capable of programming makes it possible to change processing content by changing a program, making it possible to increase degrees of freedom of design in the arithmetic unit. Furthermore, the arithmetic unit may be provided by a hard logic. Providing the arithmetic unit by a hard logic is effective in improving processing speed. The arithmetic unit may be configured by one element or may be physically configured by a plurality of elements. When the arithmetic unit is configured by a plurality of elements, each constituent element of the arithmetic unit described in the claims may be provided by another element. In this case, the plurality of elements probably configures each constituent element of one arithmetic unit. The arithmetic unit and a member having another function may be configured by one element.

As described above, as examples of the technique in the present disclosure, the exemplary embodiments are described. Accordingly, accompanying drawings and detailed description are provided.

Accordingly, some constituent elements in the accompanying drawings and the detail description may include not only constituent elements essential for solving problems, but also constituent elements that are not essential for solving problems to illustrate the above described technique. Therefore, such inessential constituent elements should be readily construed as being essential on the basis of the fact that such inessential constituent elements are shown in the accompanying drawings or mentioned in the detailed description.

Furthermore, since the above exemplary embodiments are intended to illustrate the technique of this disclosure, various changes, replacement, addition, omission, and the like are possible within the scope or range of equivalents of the claims. For example, by properly combining the arbitrary exemplary embodiments or variations of the above various exemplary embodiments or modifications, the effects possessed by them can be produced. Furthermore, a combination of exemplary embodiments, or a combination of exemplary embodiments or a combination of an exemplary embodiment and an example is possible, and a combination of features in different exemplary embodiments or examples is also possible.

The present disclosure is applicable to a display apparatus capable of setting a shade in tune with environment light without providing uncomfortable feeling. Specifically, pseudo exhibition becomes possible in which a shade of a work of art, an antique, a picture, or the like shown in a remote gallery, museum, or the like is truly displayed. Furthermore, the present disclosure is also applicable to a display apparatus such as a wall display capable of providing an impression close to a real thing even when no object exists at hand during selling of goods such as designer clothes or during auction of goods. Furthermore, the present disclosure is not only applicable to a wall display, but also applicable to an electronic apparatus having a display such as a digital still camera, a mobile phone with a movie or camera function, a smart phone, and the like.

What is claimed is:

1. A display apparatus comprising:
a display unit configured to display an image;
a recording unit configured to record three-dimensional data of an object to be displayed on the display unit; and
an arithmetic unit configured to, based on a first irradiation direction in which luminance of light irradiated on the display unit is highest, a first luminance of light from the first irradiation direction, and a second luminance of light from a direction other than the first irradiation direction, the second luminance being lower than the first luminance, calculate a shape of a shade of the object using the three-dimensional data and the first irradiation direction, calculate a density of the shade using the first luminance, and calculate a correction coefficient of the density of the shade using the second luminance,
wherein the display unit displays an image of the object shaded based on a result calculated by the arithmetic unit.

2. The display apparatus according to claim 1, further comprising
a detector configured to detect the first irradiation direction, the first luminance, and the second luminance,
wherein the arithmetic unit performs the calculations based on the first irradiation direction, the first luminance, and the second luminance detected by the detector.

3. The display apparatus according to claim 2, comprising
wherein the detector is one of a plurality of detectors,
each of the detectors is disposed at respective peripheries of the display unit, and detects the first irradiation direction, the first luminance, and the second luminance based on a result detected by the detectors.

4. The display apparatus according to claim 1, wherein
light irradiated from the first irradiation direction and having the first luminance of not less than a luminance threshold value is first light irradiated from a light source, and
light having the second luminance less than the luminance threshold value is light different from the first light irradiated from the light source.

5. The display apparatus according to claim 1, wherein
light irradiated from the first irradiation direction and having the first luminance is first light irradiated from a light source, and
light having the second luminance is ambient light different from the first light irradiated from the light source.

6. The display apparatus according to claim 1, wherein
the arithmetic unit calculates a pixel area of the shape of the shade in the display unit, and calculates the density of the shade so that a density difference of shade between adjacent pixels in the pixel area becomes not more than a predetermined value.

7. The display apparatus according to claim 1, wherein the arithmetic unit includes
a shade calculating section configured to calculate the shape of the shade of the object using the three-dimensional data and the first irradiation direction, and calculate the density of the shade using the first luminance, and
a correction coefficient calculating section configured to calculate the correction coefficient of the density of the shade using the second luminance.

8. The display apparatus according to claim 2, wherein the detector includes
a camera configured to image a periphery of the display unit,
a luminance detector configured to detect a luminance distribution using image data imaged by the camera,
a luminance area detection section configured to detect a high luminance area having luminance not less than a luminance threshold value and a low luminance area having luminance less than the luminance threshold value using the luminance distribution,
a first irradiation direction calculating section configured to calculate the first irradiation direction based on luminance information in the high luminance area,
a first luminance calculating section configured to calculate the first luminance based on the luminance information in the high luminance area, and
a second luminance calculating section configured to calculate the second luminance based on luminance information in the low luminance area.
